(19) United States
(12) Patent Application Publication
(10) Pub. No.: US 2012/0227999 A1
(43) Pub. Date: Sep. 13, 2012

(54) CABLE, CABLE DUCT AND METHODS FOR MANUFACTURING CABLE AND CABLE DUCT

(75) Inventors: Masamichi Sukegawa, Settsu-shi (JP); Hiroyuki Yoshimoto, Settsu-shi (JP)

(73) Assignee: DAIKIN INDUSTRIES, LTD., Osaka-Shi, Osaka (JP)

(21) Appl. No.: 13/508,680

(22) PCT Filed: Nov. 9, 2010
(86) PCT No.: PCT/JP2010/069921

§ 371 Date: May 8, 2012

(30) Foreign Application Priority Data
Nov. 10, 2009 (JP) 2009-257271

(51) Int. Cl. H01B 7/00; B05D 1/36; B32B 1/08; B05D 5/00

(52) U.S. Cl. 174/110 R; 427/58; 427/402; 428/36.91

(57) ABSTRACT

The present invention provides an electric wire having excellent weather resistance and durability. The present invention relates to: an electric wire, comprising: a conductor; an insulating layer formed around the periphery of the conductor; and an outer layer formed around the periphery of the insulating layer, wherein the outer layer is formed by application of a weatherproof coating material; and a production method thereof.

### TECHNICAL FIELD

The present invention relates to an electric wire and a conduit tube.

### BACKGROUND ART

In the case where electric wires having coating materials for insulation or protection of conductors are used outdoors, problematically, resins in the coating materials such as vinyl chloride and polyethylene are deteriorated by ultraviolet rays. As a result, insulation is no longer maintained, and the conductors are corroded.

A conduit tube used in the bundling of multiple electric wires has the same problem as the electric wires.

### SUMMARY OF THE INVENTION

### Problems to be Solved by the Invention

The present invention provides an electric wire and a conduit tube which have excellent weather resistance and durability.

### Means for Solving the Problems

The present invention relates to an electric wire, comprising: a conductor; an insulating layer formed around the periphery of the conductor; and an outer layer formed around the periphery of the insulating layer, wherein the outer layer is formed by application of a weatherproof coating material.

The present invention also relates to a conduit tube, comprising: a cylindrical substrate; and an outer layer formed around the periphery of the substrate, wherein the outer layer is formed by application of a weatherproof coating material.

### Effect of the Invention

The electric wire and the conduit tube of the present invention, having the above configurations, are excellent in weather resistance and durability.

### MODES FOR CARRYING OUT THE INVENTION

The electric wire of the present invention has a conductor, an insulating layer formed around the periphery of the conductor, and an outer layer formed around the periphery of the insulating layer.

The material of the conductor is not particularly limited as long as it has a good conductivity. Examples thereof include copper, copper alloy, copper clad aluminium, aluminium, silver, gold, and galvanized iron.

The shape of the conductor is not particularly limited, and may be circular or flat. If the conductor is a circular conductor, it may have a diameter of 0.05 to 50 mm.

The insulating layer is preferably formed from at least one selected from the group consisting of a rubber composition, polyethylene, polypropylene, polyvinyl chloride, polyester, and polycarbonate. Examples of the rubber composition include natural rubber, butyl rubber, chloroprene rubber, ethylene propylene rubber, chlorosulfonated polyethylene rubber, and a silicon rubber mixture. Polyethylene may be heat-resistant polyethylene or heat-resistant cross-linked polyethylene. Polyvinyl chloride may be heat-resistant polyvinyl chloride (chlorinated polyvinyl chloride).

The thickness of the insulating layer is not limited, and can be adjusted to 5 μm to 20 mm. According to the present invention, deterioration caused by sunlight can be suppressed, and therefore a thinner insulating layer can be produced. The insulating layer has at least one layer and may have multiple layers.

The outer layer is formed by application of a weatherproof coating material.

The weatherproof coating material is preferably a coating material containing a fluororesin, an acrylic resin, an acrylic silicone resin, or a silicone resin, and more preferably a fluorine-containing coating material containing a fluororesin. The weatherproof coating material may be prepared by dissolving or dispersing resin in a suitable solvent.

The fluororesin is not particularly limited as long as it has a fluorine atom. Examples thereof include solvent-soluble resins such as a fluorocarbon resin, a fluorine-containing acrylic resin, a fluorine-containing urethane resin, and a fluorine-containing silicone resin. Particularly from the viewpoints of excellent weatherability, solvent solubility, antifouling properties, and transparency, the fluororesin is preferably a fluoroolefin polymer or curable functional group-containing fluoroolefin polymer, and more preferably a curable functional group-containing fluoroolefin polymer.

Examples of the fluoroolefin polymer include polyvinylidene fluoride (PVdF), a vinylidene fluoride (VdF)/tetrafluoroethylene (TFE) copolymer, a VdF/TFE/hexafluoropropylene (HFP) copolymer, a VdF/TFE/chlorotrifluoroethylene (CTFE) copolymer, polytetrafluoroethylene (PTFE), a TFE/perfluoro(alkylvinylether) (PAVE) copolymer (PFA), an ethylene (Et)/TFE copolymer (ETFE), and polychlorotrifluoroethylene (PCTFE).

Examples of the curable functional group-containing fluoroolefin polymer include a curable functional group-containing fluoroolefin polymer obtained by copolymerizing fluoroolefin, such as TFE, CTFE, and HFP, with a functional group-containing monomer.

The curable functional group in the curable functional group-containing fluoroolefin polymer is appropriately selected according to ease of polymer production and the curing system, and is, for example, preferably at least one functional group selected from the group consisting of a hydroxyl group, a carboxyl group, an amino group, a glycidyl group, a silyl group, a silanate group, and an isocyanate group. At least one functional group selected from the group consisting of a hydroxyl group, a cyano group, and a silyl group is more preferable from the viewpoint of good curing reactivity. A hydroxyl group is particularly preferable from the viewpoints of easy availability of a polymer and good reactivity. These curable functional groups are typically introduced into a fluoropolymer by copolymerizing monomers having the curable functional groups (functional group-containing monomers).

The monomer having a curable functional group is, for example, preferably at least one monomer selected from the group consisting of a hydroxyl group-containing monomer, a carboxyl group-containing monomer, an amino group-containing monomer, and a silicone-based vinyl monomer, and more preferably a hydroxyl group-containing monomer.

### (1-1) Hydroxyl Group-Containing Monomer:

The hydroxyl group-containing monomer is preferably a hydroxyl group-containing vinyl monomer not containing a carboxyl group, and more preferably at least one selected from the group consisting of a hydroxyl group-containing vinyl ether and a hydroxyl group-containing allyl ether, and further preferably a hydroxyl group-containing vinyl ether.

The hydroxyl group-containing vinyl ether is preferably at least one selected from the group consisting of 2-hydroxyethyl vinyl ether, 3-hydroxypropyl vinyl ether, 2-hydroxypropyl vinyl ether, 2-hydroxy-2-methylpropyl vinyl ether, 4-hydroxybutyl vinyl ether, 4-hydroxy-2-methylbutyl vinyl ether, 5-hydroxypentyl vinyl ether, and 6-hydroxy hexylvinyl ether. At least one selected from the group consisting of 4-hydroxybutyl vinyl ether and 2-hydroxyethyl vinyl ether is particularly preferable among these from the viewpoints of excellent polymerization reactivity and excellent hardenability of a functional group.

The hydroxyl group-containing allyl ether is preferably at least one selected from the group consisting of 2-hydroxyethyl allyl ether, 4-hydroxybutyl allyl ether, and glycerol monoallyl ether.

Examples of the hydroxyl group-containing vinyl monomer include hydroxy alkyl esters of (meth)acrylic acid, such as 2-hydroxyethyl acrylate and 2-hydroxyethyl methacrylate.

### (1-2) Carboxyl Group-Containing Monomer:

Examples of the carboxyl group-containing monomer include unsaturated carboxylic acids represented by formula (II), such as unsaturated monocarboxylic acid, unsaturated dicarboxylic acid, and monoesters or acid anhydrides thereof:

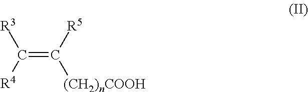

(wherein R³, R⁴, and R⁵ maybe the same as or different from one another, and they each are a hydrogen atom, an alkyl group, a carboxyl group, or an ester group; and n is 0 or 1); and carboxyl group-containing vinyl ether monomers represented by formula (III):

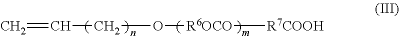

(wherein R⁶ and R⁷ may be the same as or different from each other, and they each are a saturated or unsaturated linear or cyclic alkyl group; n is 0 or 1; and m is 0 or 1.)

Specific examples of the unsaturated carboxylic acid of formula (II) include acrylic acid, methacrylic acid, vinylacetic acid, crotonic acid, cinnamic acid, 3-allyloxy propionic acid, 3-(2-allyloxyethoxycarbonyl) propionic acid, itaconic acid, itaconic acid monoester, maleic acid, maleic acid monoester, maleic anhydride, fumaric acid, fumaric acid monoester, vinyl phthalate, and vinyl pyromellitate. At least one selected from the group consisting of crotonic acid, itaconic acid, maleic acid, maleic acid monoester, fumaric acid, fumaric acid monoester, and 3-allyloxy propionic acid is preferable among these because it has a low homopolymerizability and a homopolymer is less likely to be produced.

Specific examples of the carboxyl group-containing vinyl ether monomer of formula (III) include one or more species selected from 3-(2-allyloxyethoxycarbonyl)propionic acid, 3-(2-allyloxybutoxycarbonyl)propionic acid, 3-(2-vinyloxyethoxycarbonyl)propionic acid, and 3-(2-vinyloxybutoxycarbonyl)propionic acid. 3-(2-Allyloxyethoxycarbonyl) propionic acid and the like are advantageous and preferable among these in terms of good stability and polymerization reactivity of a monomer.

### (1-3) Amino Group-Containing Monomer:

Examples of the amino group-containing monomer include aminovinyl ethers represented by CH₂═CH—O—(CH₂)ₓ—NH₂ (x=0 to 10); allylamines represented by CH₂═CH—O—CO(CH₂)ₓ—NH₂ (x=1 to 10); aminomethyl styrene; vinylamine; acrylamide; vinylacetamide; and vinylformamide.

### (1-4) Silicone-Based Vinyl Monomer:

Examples of the silicone-based vinyl monomer include (meth)acrylic esters such as CH₂═CHCO₂(CH₂)₃Si(OCH₃)₃, CH₂═CHCO₂(CH₂)₃Si(OC₂H₅)₃CH₂═C(CH₃)CO₂(CH₂)₃Si(OCH₃)₃, CH₂═C(CH₃)CO₂(CH₂)₃Si(OC₂H₅)₃,CH₂—CHCO₂(CH₂)₃SiCH₃(OC₂H₅)₂, CH₂═C(CH₃)CO₂(CH₂)₃SiC₂H₅(OCH₃)₂, CH₂═C(CH₃)CO₂(CH₂)₃Si(CH₃)₂(OC₂H₅), CH₂═C(CH₃)CO₂(CH₂)₃Si(CH₃)₂OH, CH₂═CH(CH₂)₃Si(OCOCH₃)₃, CH₂═C(CH₃)CO₂(CH₂)₃SiC₂H₅(OCOCH₃)₂, CH₂═C(CH₃)CO₂(CH₂)₃SiCH₃(N(CH₃)COCH₃)₂, CH₂═CHCO₂(CH₂)₃SiCH₃[ON(CH₃)C₂H₅]₂, and CH₂═C(CH₃) CO₂(CH₂)₃SiC₆H₅[ON(CH₃) C₂H₅]₂; vinylsilanes such as CH₂═CHSi[ON═C(CH₃)(C₂H₅)₃, CH₂═CHSi(OCH₃)₃, CH₂═CHSi(OC₂H₅)₃, CH₂═CHSiCH₃(OCH₃)₂, CH₂═CHS(OCOCH₃)₃, CH₂═CHSi(CH₃)₂(OC₂H₅), CH₂═CHSi(CH₃)₂SiCH₃(OCH₃)₂, CH₂CHSiC₂H₅(OCOCH₃)₂, CH₂═CHSiOH₃[ON(CH₃)C₂H₅]₂, and vinyl trichlorosilane or partial hydrolysates thereof; vinyl ethers such as trimethoxysilylethyl vinyl ether, triethoxysilylethyl vinyl ether, trimethoxysilylbutyl vinyl ether, methyldimethoxysilylethyl vinyl ether, trimethoxysilylpropyl vinyl ether, and triethoxysilylpropyl vinyl ether.

A polymerization unit derived from the monomer having a curable functional group is preferably 8 to 30% by mole of the total polymerization units of a fluoropolymer having a curable functional group. The more preferable lower limit thereof is 10% by mole, and the more preferable upper limit thereof is 20% by mole.

The fluoropolymer having a curable functional group preferably includes a polymerization unit derived from a fluorine-containing vinyl monomer.

The fluorine-containing vinyl monomer is preferably at least one selected from the group consisting of tetrafluoroethylene (TFE), vinylidene fluoride, chlorotrifluoroethylene (CTFE), vinyl fluoride, hexafluoropropylene, and perfluoroalkyl vinyl ether. The fluorine-containing vinyl monomer is more preferably at least one selected from the group consisting of TFE, CTFE, and vinylidene fluoride in terms of excellence in permittivity, low dielectric loss tangent, dispersibility, moisture resistance, heat resistance, flame retardancy, adhesiveness, copolymerizability, chemical resistance, and the like. The fluorine-containing vinyl monomer is further preferably at least one selected from the group consisting of TFE and CTFE, and particularly preferably TFE, in terms of excellence in low permittivity, low dielectric loss tangent, and weather resistance, as well as moistureproofness.

A repeating unit derived from the fluorine-containing vinyl monomer is preferably 20 to 49% by mole of the total monomer units of the fluoropolymer having a curable functional group. The lower limit thereof is more preferably 30% by mole, and further preferably 40% by mole . The upper limit thereof is more preferably 47% by mole.

The fluoropolymer having a curable functional group preferably has a repeating unit derived from at least one vinyl monomer (excluding one having a fluorine atom) selected from the group consisting of carboxylic acid vinyl ester, alkyl vinyl ether, and non-fluorinated olefin. The carboxylic acid vinyl ester has an effect of improving compatibility. Examples of the carboxylic acid vinyl ester include vinyl acetate, vinyl propionate, vinyl butyrate, vinyl isobutyrate, vinyl pivalate, vinyl caproate, vinyl versatate, vinyl laurate, vinyl stearate, vinyl cyclohexylcarboxylate, vinyl benzoate, and vinyl para-t-butylbenzoate. Examples of the alkyl vinyl ether include methyl vinyl ether, ethyl vinyl ether, butyl vinyl ether, and cyclohexyl vinyl ether. Examples of the non-fluorinated olefin include ethylene, propylene, n-butene, and isobutene.

Repeating units derived from the vinyl monomer (except for one having a fluorine atom) are preferably the total monomer units other than monomer units including a repeating unit derived from the hydroxyl group-containing vinyl monomer and the repeating unit derived from the fluorine-containing vinyl monomer among the total monomer units of the fluoropolymer having a curable functional group.

Examples of the fluoropolymer into which a curable functional group is introduced are as follows in terms of its structural unit.

Examples of the fluoropolymer having a curable functional group include a perfluoroolefin polymer mainly including a perfluoroolefin unit, a chlorotrifluoroethylene (CTFE) polymer mainly including a CTFE unit, a vinylidene fluoride (VdF) polymer mainly including a VdF unit, a fluoroalkyl group-containing polymer mainly including a fluoroalkyl unit.

### (1) Perfluoroolefin Polymer Mainly Including a Perfluoroolefin Unit

Specific examples thereof include a homopolymer of tetrafluoroethylene (TFE), a copolymer of TFE with hexafluoropropylene (HFP), perfluoro (alkyl vinyl ether) (PAVE), or the like, and other monomers copolymerizable with these.

Examples of the other copolymerizable monomers include, but are not limited to, carboxylic acid vinyl esters such as vinyl acetate, vinyl propionate, vinyl butyrate, vinyl isobutyrate, vinyl pivalate, vinyl caproate, vinyl versatate, vinyl laurate, vinyl stearate, vinyl cyclohexylcarboxylate, vinyl benzoate, and vinyl para-t-butylbenzoate; alkyl vinyl ethers such as methyl vinyl ether, ethyl vinyl ether, butyl vinyl ether, and cyclohexyl vinyl ether; non-fluorinated olefins such as ethylene, propylene, n-butene, and isobutene; fluoromonomers such as vinylidene fluoride (VdF), chlorotrifluoroethylene (CTFE), vinyl fluoride (VF), and fluorovinyl ether.

The TFE polymer mainly including TFE is preferable among these in terms of excellence in pigment dispersibility, weather resistance, copolymerizability, and chemical resistance.

Specific examples of the fluoropolymer having a curable functional group include a copolymer of TFE/isobutylene/hydroxybutyl vinyl ether/other monomers, a copolymer of TFE/vinyl versatate/hydroxybutyl vinyl ether/other monomers, and a copolymer of TFE/VdF/hydroxybutyl vinyl ether/other monomers. Particularly, at least one copolymer selected from the group consisting of a copolymer of TFE/isobutylene/hydroxybutyl vinyl ether/other monomers and a copolymer of TFE/vinyl versatate/hydroxybutyl vinyl ether/other monomers is preferable.

### (2) Chlorotrifluoroethylene (CTFE) Polymer Mainly Including a CTFE Unit

Specific examples thereof include a copolymer of CTFE/hydroxybutyl vinyl ether/other monomers.

### (3) Vinylidene Fluoride (VdF) Polymer Mainly Including a VdF Unit

Specific examples thereof include a copolymer of VdF/TFE/hydroxybutyl vinyl ether/other monomers.

### (4) Fluoroalkyl Group-Containing Polymer Mainly Including a Fluoroalkyl Unit

Specific examples thereof include CF₃CF₂(CF₂CF₂)ₙCH₂CH₂OCOCH═CH₂ (a mixture of those with n being 3 and 4)/2-hydroxyethyl methacrylate/stearyl acrylate copolymer.

In consideration of weather resistance and moistureproofness, a perfluoroolefin polymer is preferable among these.

The solvent is not limited as long as it can dissolve or disperse resin. The solvent is preferably water or liquid. Examples of the liquid include butyl acetate, xylene, and coal tar naphtha.

The weatherproof coating material may contain at least one additive selected from the group consisting of an ultraviolet absorbent, an ultraviolet reflective agent, and an infrared reflective agent. Examples of the additive include: organic ultraviolet absorbents such as a benzophenone compound, a benzotriazol compound, a triazine compound, a cyanoacrylate compound, and an oxalic anilide compound; and inorganic pigments such as carbon black, titanium oxide, barium titanate, zirconium oxide, yttrium oxide, indium oxide, magnesium oxide, zinc oxide, calcium oxide, barium oxide, cerium oxide, barium sulfate, silica, aluminum oxide, and iron oxide.

The weatherproof coating material may contain a curing agent and a curing catalyst in order to improve coating performances such as hardness and weather resistance of a coating film. Examples of the curing agent include a known isocyanate curing agent, and a known melamine curing agent. Examples of the curing catalyst include an aluminium compound and a tin compound.

The weatherproof coating material may contain an inorganic'heat shielding pigment and an organic heat shielding pigment which are particularly excellent in light reflection efficiency in an infrared region. Examples of the inorganic heat shielding pigment include ceramic pigments such as glass fine powders, glass balloons, and ceramic beads; metal particle pigments such as aluminium, iron, zirconium, and cobalt; metal oxide pigments such as titanium oxide, magnesium oxide, barium oxide, calcium oxide, zinc oxide, zirconium oxide, yttrium oxide, indium oxide, sodium titanate, silicon oxide, nickel oxide, manganese oxide, chrome oxide, iron oxide, copper oxide, cerium oxide, and aluminium oxide; complex oxide pigments such as iron oxide-manganese oxide, iron oxide-chrome oxide, and copper oxide-magnesium oxide; metal pigments such as Si, Al, Fe, magnesium, manganese, nickel, titanium, chromium, and calcium; alloy pigments such as iron-chromium, bismuth-manganese, iron-manganese, and manganese-yttrium; mica; silicon nitride; surface-treated covering pigments; luster pigments; and barium sulfate. In the present invention, each of these may be used alone, or two or more kinds may be used in combination. The organic heat shielding pigment is preferably, for example, one that absorbs light in a visible region and has a high light reflectance in an infrared region. The light reflectance in an infrared region is preferably 10% or higher. The organic heat shielding pigment is one or more pigments selected from pigments such as azo pigments, azomethine pigments, lake pigments, thioindigo pigments, anthraquinone pigments (e.g., anthanthrone pigments, diamino anthraquinonyl pigments, indanthrone pigments, flavanthrone pigments, anthrapyrimidine pigments), perylene pigments, perinone pigments, diketopyrrolopyrrole pigments, dioxazine pigments, phthalocyanine pigments, quinophthalone pigments, quinacridone pigments, isoindoline pigments, isoindolinone pigments, and carbon pigments.

The electric wire of the present invention may have a primer layer between the insulating layer and the outer layer.

The primer layer can be formed by primer application and drying. The primer is not particularly limited as long as the adhesion between the insulating layer and the outer layer is improved. Examples of the primer include acrylic primer, olefin primer, chlorinated-polyolefin primer, urethane primer, vinyl chloride primer, epoxy primer, and polymethyl methacrylate primer. The primer preferably contains epoxy resin, urethane resin, acrylic resin, silicone resin, and polyester resin.

The thickness of the primer layer can be adjusted to about 1 to 20 μm.

The electric wire of the present invention is preferable especially as an electric wire to be used under exposure to sunlight.

The electric wire of the present invention can be suitably produced by a production method including applying a weatherproof coating material to the covered wire having the conductor and the insulating layer formed around the periphery of the conductor. The production method is another aspect of the present invention.

The method for producing the electric wire of the present invention may be a method including: applying the primer to a covered wire having the conductor and the insulating layer formed around the periphery of the conductor to form the primer layer; and applying the weatherproof coating material onto the primer layer.

The primer and the weatherproof coating material can be applied by a conventionally known method. After applied, the primer and the weatherproof coating material may be dried and/or fired if desired. The primer can be fired by a conventionally known method, for example, at 30° C. to 300° C. for 0.1 to 2 hours as long as the material of the insulating layer is not deteriorated.

The covered wire has the conductor and the insulating layer formed around the periphery of the conductor. The covered wire itself has been conventionally used as an electric wire, but is inferior to the electric wire of the present invention in weather resistance.

A conduit tube having a cylindrical substrate and an outer layer formed around the periphery of the substrate is another aspect of the present invention.

The substrate is preferably formed from at least one selected from the group consisting of polyethylene, polypropylene, polyvinyl chloride, polyester, and polycarbonate.

The diameter of the substrate can be appropriately selected in consideration of the diameter and the number of the electric wires accommodated therein, and the substrate may have, for example, an internal diameter of 0.05 to 100 mm and a thickness of 0.05 to 5 mm. The wall shape of the cylindrical substrate may be straight or have a bellows structure.

The outer layer is formed by application of a weatherproof coating material.

The weatherproof coating material is preferably a coating material containing a fluororesin, an acrylic resin, an acrylic silicone resin, or a silicone resin, and more preferably a fluorine-containing coating material containing a fluororesin. The weatherproof coating material may be prepared by dissolving or dispersing resin in a suitable solvent.

The fluororesin is not particularly limited as long as it has a fluorine atom. Examples thereof include solvent-soluble resins such as a fluorocarbon resin, a fluorine-containing acrylic resin, a fluorine-containing urethane resin, and a fluorine-containing silicone resin. Particularly from the viewpoints of excellent weatherability, solvent solubility, antifouling properties, and transparency, the fluororesin is preferably a fluoroolefin polymer or curable functional group-containing fluoroolefin polymer, and more preferably a curable functional group-containing fluoroolefin polymer.

Examples of the fluoroolefin polymer include polyvinylidene fluoride (PVdF), a vinylidene fluoride (VdF)/tetrafluoroethylene (TFE) copolymer, a VdF/TFE/hexafluoropropylene (HFP) copolymer, a VdF/TFE/chlorotrifluoroethylene (CTFE) copolymer, polytetrafluoroethylene (PTFE), a TFE/perfluoro(alkylvinylether) (PAVE) copolymer (PFA), an ethylene (Et)/TFE copolymer (ETFE), and polychlorotrifluoroethylene (PCTFE).

Examples of the curable functional group-containing fluoroolefin polymer include a curable functional group-containing fluoroolefin polymer obtained by copolymerizing fluoroolefin, such as TFE, CTFE, and HFP, with a functional group-containing monomer.

The curable functional group in the curable functional group-containing fluoroolefin polymer is appropriately selected according to the ease of polymer production and the curing system, and is, for example, preferably at least one functional group selected from the group consisting of a hydroxyl group, a carboxyl group, an amino group, a glycidyl group, a silyl group, a silanate group, and an isocyanate group. At least one functional group selected from the group consisting of a hydroxyl group, a cyano group, and a silyl group is more preferable from the viewpoint of good curing reactivity. A hydroxyl group is particularly preferable from the viewpoints of easy availability of a polymer and good reactivity. These curable functional groups are typically introduced into a fluoropolymer by copolymerizing monomers having curable functional groups (functional group-containing monomers).

The monomer having a curable functional group is, for example, preferably at least one monomer selected from the group consisting of a hydroxyl group-containing monomer, a carboxyl group-containing monomer, an amino group-containing monomer, and a silicone-based vinyl monomer, and more preferably a hydroxyl group-containing monomer.

### (1-1) Hydroxyl Group-Containing Monomer:

The hydroxyl group-containing monomer is preferably a hydroxyl group-containing vinyl monomer not containing a carboxyl group, and more preferably at least one selected from the group consisting of a hydroxyl group-containing vinyl ether and a hydroxyl group-containing allyl ether, and further preferably a hydroxyl group-containing vinyl ether.

The hydroxyl group-containing vinyl ether is preferably at least one selected from the group consisting of 2-hydroxyethyl vinyl ether, 3-hydroxypropyl vinyl ether, 2-hydroxypropyl vinyl ether, 2-hydroxy-2-methylpropyl vinyl ether, 4-hydroxybutyl vinyl ether, 4-hydroxy-2-methylbutyl vinyl ether, 5-hydroxypentyl vinyl ether, and 6-hydroxy hexylvinyl ether. At least one selected from the group consisting of 4-hydroxybutyl vinyl ether and 2-hydroxyethyl vinyl ether is particularly preferable among these from the viewpoints of excellent polymerization reactivity and excellent hardenability of a functional group.

The hydroxyl group-containing allyl ether is preferably at least one selected from the group consisting of 2-hydroxyethyl allyl ether, 4-hydroxybutyl allyl ether, and glycerol monoallyl ether.

Examples of the hydroxyl group-containing vinyl monomer include hydroxy alkyl esters of (meth)acrylic acid, such as 2-hydroxyethyl acrylate and 2-hydroxyethyl methacrylate.

### (1-2) Carboxyl Group-Containing Monomer:

Examples of the carboxyl group-containing monomer include unsaturated carboxylic acids represented by formula (II), such as unsaturated monocarboxylic acid, unsaturated dicarboxylic acid, and monoesters or acid anhydrides thereof:

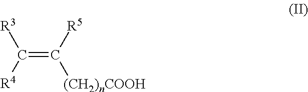

(wherein R³, R⁴, and R⁵ may be the same as or different from one another, and they each are a hydrogen atom, an alkyl group, a carboxyl group, or an ester group; and n is 0 or 1); and carboxyl group-containing vinyl ether monomers represented by formula (III):

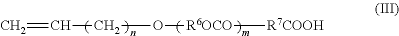

(wherein R⁶ and R⁷ may be the same as or different from each other, and they each are a saturated or unsaturated linear or cyclic alkyl group; n is 0 or 1; and m is 0 or 1.)

Specific examples of the unsaturated carboxylic acid of formula (II) include acrylic acid, methacrylic acid, vinylacetic acid, crotonic acid, cinnamic acid, 3-allyloxy propionic acid, 3-(2-allyloxyethoxycarbonyl)propionic acid, itaconic acid, itaconic acid monoester, maleic acid, maleic acid monoester, maleic anhydride, fumaric acid, fumaric acid monoester, vinyl phthalate, and vinyl pyromellitate. At least one selected from the group consisting of crotonic acid, itaconic acid, maleic acid, maleic acid monoester, fumaric acid, fumaric acid monoester, and 3-allyloxy propionic acid is preferable among these because it has a low homopolymerizability and a homopolymer is less likely to be produced.

Specific examples of the carboxyl group-containing vinyl ether monomer of formula (III) include one or more species selected from 3-(2-allyloxyethoxycarbonyl)propionic acid, 3-(2-allyloxybutoxycarbonyl)propionic acid, 3-(2-vinyloxyethoxycarbonyl)propionic acid, and 3-(2-vinyloxybutoxycarbonyl)propionic acid. 3-(2-Allyloxyethoxycarbonyl) propionic acid and the like are advantageous and preferable among these in terms of good stability and polymerization reactivity of a monomer.

### (1-3) Amino Group-Containing Monomer:

Examples of the amino group-containing monomer include aminovinyl ethers represented by CH₂═CH—O—(CH₂)ₓ—NH₂ (x=0 to 10); allylamines represented by CH₂═CH—O—CO(CH₂)ₓ—NH₂ (x=1 to 10); aminomethyl styrene; vinylamine; acrylamide; vinylacetamide; and vinylformamide.

### (1-4) Silicone-Based Vinyl Monomer:

Examples of the silicone-based vinyl monomer include (meth)acrylic esters such as CH₂═CHCO₂(CH₂)₃Si(OCH₃)₃, CH₂═CHCO₂(CH₂)₃Si(OC₂H₅)₃, CH₂═C(CH₃)CO₂(CH₂)₃Si(OCH₃)₃, CH₂═C(CH₃)CO₂(CH₂)₃Si(OC₂H₅)₃, CH₂═CHCO₂(CH₂)₃SiCH₃(C₂H₅)₂, CH₂═C(CH₃)CO₂(CH₂)₃SiC₂H₅(OCH₃)₂, CH₂═C(CH₃)CO₂(CH₂)₃Si(CH₃)₂(OC₂H₅), CH₂═C(CH₃)CO₂(CH₂)₃Si(CH₃)₂OH, CH₂═CH(CH₂)₃Si(OCOH₃)₃, CH₂═C(CH₃)CO₂(CH₂)₃SiC₂H₅(OCOCH₃)₂, CH₂═C(CH₃)CO₂(CH₂)₃SiCH₃(N(CH₃)COCH₃)₂, CH₂═CHCO₂(CH₂)₃SiCH₃[ON(CH₃)C₂H₅]₂, and CH₂═C(CH₃)CO₂(CH₂)₃SiC₆H₅[ON(CH₃)C₂H₅]₂; vinylsilanes such as CH₂═CHSi[ON═C(CH₃)(C₂H₅)]₃, CH₂═CHSi(OCH₃)₃, CH₂═CHSi(OC₂H₅)₃, CH₂═CHSiCH₃(OCH₃)₂, CH₂═CHSi(OCOCH₃)₃, CH₂═CHSi (CH₃)₂(OC₂H₅), CH₂═CHSi(CH₃)₂SiCH₃(OCH₃)₂, CH₂═CHSiC₂H₅(OCOCH₃)₂, CH₂═CHSiCH₃[ON(CH₃)C₂H₅]₂, and vinyl trichlorosilane or partial hydrolysates thereof; vinyl ethers such as trimethoxysilylethyl vinyl ether, triethoxysilylethyl vinyl ether, trimethoxysilylbutyl vinyl ether, methyldimethoxysilylethyl vinyl ether, trimethoxysilylpropyl vinyl ether, and triethoxysilylpropyl vinyl ether.

A polymerization unit derived from the monomer having a curable functional group is preferably 8 to 30% by mole of the total polymerization units of a fluoropolymer having a curable functional group. The more preferable lower limit thereof is 10% by mole, and the more preferable upper limit thereof is 20% by mole.

The fluoropolymer having a curable functional group preferably includes a polymerization unit derived from a fluorine-containing vinyl monomer.

The fluorine-containing vinyl monomer is preferably at least one selected from the group consisting of tetrafluoroethylene (TFE), vinylidene fluoride, chlorotrifluoroethylene (CTFE), vinyl fluoride, hexafluoropropylene, and perfluoroalkyl vinyl ether. The fluorine-containing vinyl monomer is more preferably at least one selected from the group consisting of TFE, CTFE, and vinylidene fluoride in terms of excellence in permittivity, low dielectric loss tangent, dispersibility, moisture resistance, heat resistance, flame retardancy, adhesiveness, copolymerizability, chemical resistance, and the like. The fluorine-containing vinyl monomer is further preferably at least one selected from the group consisting of TFE and CTFE, and particularly preferably TFE, in terms of excellence in low permittivity, low dielectric loss tangent, and weather resistance, as well as moistureproofness.

A repeating unit derived from the fluorine-containing vinyl monomer is preferably 20 to 49% by mole of the total monomer units of the fluoropolymer having a curable functional group. The lower limit thereof is more preferably 30% by mole, and further preferably 40% by mole. The upper limit thereof is more preferably 47% by mole.

The fluoropolymer having a curable functional group preferably has a repeating unit derived from at least one vinyl monomer (excluding one having a fluorine atom) selected from the group consisting of carboxylic acid vinyl ester, alkyl vinyl ether, and non-fluorinated olefin. The carboxylic acid vinyl ester has an effect of improving compatibility. Examples of the carboxylic acid vinyl ester include vinyl acetate, vinyl propionate, vinyl butyrate, vinyl isobutyrate, vinyl pivalate, vinyl caproate, vinyl versatate, vinyl laurate, vinyl stearate, vinyl cyclohexylcarboxylate, vinyl benzoate, and vinyl para-t-butylbenzoate. Examples of the alkyl vinyl ether include methyl vinyl ether, ethyl vinyl ether, butyl vinyl ether, and cyclohexyl vinyl ether. Examples of the non-fluorinated olefin include ethylene, propylene, n-butene, and isobutene.

Repeating units derived from the vinyl monomer (except for one having a fluorine atom) are preferably the total monomer units other than monomer units including a repeating unit derived from the hydroxyl group-containing vinyl monomer and the repeating unit derived from the fluorine-containing vinyl monomer among the total monomer units of the fluoropolymer having a curable functional group.

Examples of the fluoropolymer into which a curable functional group is introduced are as follows in terms of its structural unit.

Examples of the fluoropolymer having a curable functional group include a perfluoroolefin polymer mainly including a perfluoroolefin unit, a chlorotrifluoroethylene (CTFE) polymer mainly including a CTFE unit, a vinylidene fluoride (VdF) polymer mainly including a VdF unit, a fluoroalkyl group-containing polymer mainly including a fluoroalkyl unit.

### (1) Perfluoroolefin Polymer Mainly Including a Perfluoroolefin Unit

Specific examples thereof include a homopolymer of tetrafluoroethylene (TFE), a copolymer of TFE with hexafluoropropylene (HFP), perfluoro (alkyl vinyl ether) (PAVE), or the like, and other monomers copolymerizable with these.

Examples of the other copolymerizable monomers include, but are not limited to, carboxylic acid vinyl esters such as vinyl acetate, vinyl propionate, vinyl butyrate, vinyl isobutyrate, vinyl pivalate, vinyl caproate, vinyl versatate, vinyl laurate, vinyl stearate, vinyl cyclohexylcarboxylate, vinyl benzoate, and vinyl para-t-butylbenzoate; alkyl vinyl ethers such as methyl vinyl ether, ethyl vinyl ether, butyl vinyl ether, and cyclohexyl vinyl ether; non-fluorinated olefins such as ethylene, propylene, n-butene, and isobutene; fluoromonomers such as vinylidene fluoride (VdF), chlorotrifluoroethylene (CTFE), vinyl fluoride (VF), and fluorovinyl ether.

The TFE polymer mainly including TFE is preferable among these in terms of excellence in pigment dispersibility, weather resistance, copolymerizability, and chemical resistance.

Specific examples of the fluoropolymer having a curable functional group include a copolymer of TFE/isobutylene/hydroxybutyl vinyl ether/other monomers, a copolymer of TFE/vinyl versatate/hydroxybutyl vinyl ether/other monomers, and a copolymer of TFE/VdF/hydroxybutyl vinyl ether/other monomers. Particularly, at least one copolymer selected from the group consisting of a copolymer of TFE/isobutylene/hydroxybutyl vinyl ether/other monomers and a copolymer of TFE/vinyl versatate/hydroxybutyl vinyl ether/other monomers is preferable.

### (2) Chlorotrifluoroethylene (CTFE) Polymer Mainly Including a CTFE Unit

Specific examples thereof include a copolymer of CTFE/hydroxybutyl vinyl ether/other monomers.

### (3) Vinylidene Fluoride (VdF) Polymer Mainly Including a VdF Unit

Specific examples thereof include a copolymer of VdF/TFE/hydroxybutyl vinyl ether/other monomers.

### (4) Fluoroalkyl Group-Containing Polymer Mainly Including a Fluoroalkyl Unit

Specific examples thereof include CF₃CF₂(CF₂CF₂)ₙCH₂CH₂OCOCH═CH₂ (a mixture of those with n being 3 and 4)/2-hydroxyethyl methacrylate/stearyl acrylate copolymer.

In consideration of weather resistance and moistureproofness, a perfluoroolefin polymer is preferable among these.

The solvent is not limited as long as it can dissolve or disperse resin. The solvent is preferably water or liquid. Examples of the liquid include butyl acetate, xylene, and coal tar naphtha.

The weatherproof coating material may contain at least one additive selected from the group consisting of an ultraviolet absorbent, an ultraviolet reflective agent, and an infrared reflective agent. Examples of the additive include: organic ultraviolet absorbents such as a benzophenone compound, a benzotriazol compound, a triazine compound, a cyanoacrylate compound, and an oxalic anilide compound; and inorganic pigments such as carbon black, titanium oxide, barium titanate, zirconium oxide, yttrium oxide, indium oxide, magnesium oxide, zinc oxide, calcium oxide, barium oxide, cerium oxide, barium sulfate, silica, aluminum oxide, and iron oxide.

The weatherproof coating material may contain a curing agent and a curing catalyst in order to improve coating performances such as hardness and weather resistance of a coating film. Examples of the curing agent include a known isocyanate curing agent, and a known melamine curing agent. Examples of the curing catalyst include an aluminium compound and a tin compound.

The weatherproof coating material may contain an inorganic heat shielding pigment and an organic heat shielding pigment which are particularly excellent in light reflection efficiency in an infrared region. Examples of the inorganic heat shielding pigment include ceramic pigments such as glass fine powders, glass balloons, and ceramic beads ; metal particle pigments such as aluminium, iron, zirconium, and cobalt; metal oxide pigments such as titanium oxide, magnesium oxide, barium oxide, calcium oxide, zinc oxide, zirconium oxide, yttrium oxide, indium oxide, sodium titanate, silicon oxide, nickel oxide, manganese oxide, chrome oxide, iron oxide, copper oxide, cerium oxide, and aluminium oxide; complex oxide pigments such as iron oxide-manganese oxide, iron oxide-chrome oxide, and copper oxide-magnesium oxide; metal pigments such as Si, Al, Fe, magnesium, manganese, nickel, titanium, chromium, and calcium; alloy pigments such as iron-chromium, bismuth-manganese, iron-manganese, and manganese-yttrium; mica; silicon nitride; surface-treated covering pigments; luster pigments; and barium sulfate. In the present invention, each of these may be used alone, or two or more kinds may be used in combination. The organic heat shielding pigment is preferably, for example, one that absorbs light in a visible region and has a high light reflectance in an infrared region. The light reflectance in an infrared region is preferably 10% or higher. The organic heat shielding pigment is one or more pigments selected from pigments such as azo pigments, azomethine pigments, lake pigments, thioindigo pigments, anthraquinone pigments (e.g., anthanthrone pigments, diamino anthraquinonyl pigments, indanthrone pigments, flavanthrone pigments, anthrapyrimidine pigments), perylene pigments, perinone pigments, diketopyrrolopyrrole pigments, dioxazine pigments, phthalocyanine pigments, quinophthalone pigments, quinacridone pigments, isoindoline pigments, isoindolinone pigments, and carbon pigments.

The conduit tube of the present invention may have a primer layer between the substrate and the outer layer.

The primer layer can be formed by primer application and drying. The primer is not particularly limited as long as the adhesion between the insulating layer and the outer layer is improved. Examples of the primer include acrylic primer, olefin primer, chlorinated-polyolefin primer, urethane primer, vinyl chloride primer, epoxy primer, and polymethyl methacrylate primer. The primer preferably contains epoxy resin, urethane resin, acrylic resin, silicone resin, and polyester resin.

The thickness of the primer layer can be adjusted to about 1 to 20 μm.

The conduit tube of the present invention is a cylindrical tube that can accommodate the electric wire, and may be flexible or made of metal or resin. The wall shape of the Conduit tube may be flat or bellows-like, or have irregularities.

Deterioration of the electric wire can be suppressed by covering, with the conduit tube of the present invention, the electric wire used especially under exposure to sunlight. For example, the conduit tube is suitable for the application in which multiple wirings used for solar cells are bundled.

The conduit tube of the present invention can be suitably produced by a production method including applying the weatherproof coating material to the periphery of the cylindrical substrate. The production method is another aspect of the present invention.

The method for producing the conduit tube of the present invention may be a method including: applying the primer to the periphery of the cylindrical substrate to form the primer layer; and applying the weatherproof coating material onto the primer layer.

The primer and the weatherproof coating material can be applied by a conventionally known method. After applied, the primer and the weatherproof coating material may be dried and/or fired if desired. The primer can be fired by a conventionally known method, for example, at 30° C. to 300° C. for 0.1 to 2 hours as long as the substrate is not deteriorated.

### EXAMPLES

Next, the present invention will be described referring to examples, and the present invention is not limited only to these examples.

The respective values of examples were measured by the following method.

### Thickness of Layer

The thickness of a layer was measured in conformity with JIS C 3003.

### Example 1

A vinyl chloride covered wire in conformity with UL1015 standard was immersed in a polymethyl methacrylate primer (trade name: Elvacite 2021, produced by Lucite International Inc.), and dried at 100° C. for 5 minutes to form a 5-μm-thick primer layer. Further, the vinyl chloride covered wire including the primer layer was immersed in a mixed composition of a weatherproof coating material preliminarily prepared (trade name: ZEFFLE GK570, produced by Daikin Industries, Ltd., solids concentration: 65% by mass) and a curing agent (trade name: Sumijule N3300, produced by Sumika Bayer Urethane Co., Ltd.) (the mixing ratio of the weatherproof coating material to the curing agent was 10:1 in terms of solids content). Then, the resultant mixture was passed through an 80° C. firing furnace over 10 minutes, so that a 10-μm-thick outer layer was formed around the periphery of the primer layer, and thereby an electric wire was produced.

### Example 2

A polyethylene tube having an internal diameter of 10 mm was immersed in a polymethyl methacrylate primer identical to that of Example 1, and dried at 100° C. for 5 minutes to form a 5-μm-thick primer layer. Further, the polyethylene tube including the primer layer was immersed in a mixed composition of a weatherproof coating material preliminarily prepared (trade name: ZEFFLE GK570, produced by Daikin Industries, Ltd., solids concentration: 65% by mass) and a curing agent (trade name: Sumijule N3300, produced by Sumika Bayer Urethane Co., Ltd.) (the mixing ratio of the weatherproof coating material to the curing agent was 10:1 in terms of solids content). Then, the resultant mixture was passed through an 80° C. firing furnace over 10 minutes, so that a 10-μm-thick outer layer was formed around the periphery of the primer layer, and thereby a conduit tube was produced.

1. An electric wire, comprising:
a conductor;
an insulating layer formed around the periphery of the conductor; and
an outer layer formed around the periphery of the insulating layer,
wherein the outer layer is formed by application of a weatherproof coating material.

2. The electric wire according to claim 1,
wherein the weatherproof coating material is a fluorine-containing coating material.

3. The electric wire according to claim 1, further comprising:
a primer layer between the insulating layer and the outer layer.

4. A method for producing the electric wire according to claim 1, comprising:
applying the weatherproof coating material to a covered wire having the conductor and the insulating layer formed around the periphery of the conductor.

5. A method for producing the electric wire according to claim 1, comprising:
applying a primer to a covered wire having the conductor and the insulating layer formed around the periphery of the conductor to form the primer layer; and
applying the weatherproof coating material onto the primer layer.

6. A conduit tube, comprising:
a cylindrical substrate; and
an outer layer formed around the periphery of the substrate,
wherein the outer layer is formed by application of a weatherproof coating material.

7. The conduit tube according to claim 6,
wherein the weatherproof coating material is a fluorine-containing coating material.

8. The conduit tube according to claim 6, further comprising:
a primer layer between the substrate and the outer layer.

9. A method for producing the conduit tube according to claim 6, comprising:
applying the weatherproof coating material to the cylindrical substrate.

10. A method for producing the conduit tube according to claim 6, comprising:
applying a primer to the cylindrical substrate to form the primer layer; and
applying the weatherproof coating material onto the primer layer.
